(19) United States
(12) Patent Application Publication
(10) Pub. No.: US 2009/0169824 A1
(43) Pub. Date: Jul. 2, 2009

(54) Rubber Profile for Flood Gate Sealing, Manufacturing System and Product thereof obtained

(76) Inventor: Lizete Lombardi Awazu, Sao Paulo (BR)

Correspondence Address: KEVIN W. GRIERSON;FSB LEGAL COUNSEL, 4610 VICTORIA BLVD., HAMPTON, VA, 23669, US

(21) Appl. No.: 12/275,446

(22) Filed: Nov. 21, 2008

(30) Foreign Application Priority Data
Nov. 21, 2007 (BR) 018070076331

(51) Int. Cl. B32B 3/30; B32B 27/00; B26D 3/12

(52) U.S. Cl. 428/167; 428/422; 428/156; 83/13

(57) ABSTRACT

1—“IMPROVEMENT IN RUBBER PROFILE FOR FLOOD GATES SEALING, MANUFACTURING SYSTEM AND PRODUCT THEREOF OBTAINED”, comprising the junction of components; [1] PTFE film (polytetrafluorethylene): sintered and laminated 0.8 or 1.6 mm thick, chemically treated in one of the faces in order to allow the adhesion to the rubber; [2] Primer/adhesive: system of organic polymers dissolved in solvent, which promote the adhesion of several substrates to the elastomers; [3] Rubber: synthetic or natural elastomer compound; being the film [1] transversally grooved [4].

The present description for this “IMPROVEMENT IN RUBBER PROFILE FOR FLOOD GATE SEALING, MANUFACTURING SYSTEM AND PRODUCT THEREOF OBTAINED”, as presents its denomination, regards to a system for improvement of profiles used in hydraulic flood gates for hydroelectric power stations, barrages, locks, dams, sanitation, water treatment etc., i.e. for contention/sealing of big water volumes.

The mentioned sealing profiles are installed directly in the flood gate boards with mechanical attachment, using screws, metallic splints or even clamps.

Through which is known about the current state-of-the-technique, this conventional sealing causes many leakages, being generally caused by several reasons, namely: design or installation error, insufficient maintenance, etc.

The function of the system herein presented as an improvement is not to prevent leakages in the cases above mentioned, but to prevent common damages occurring exactly in sealing profiles with conventional lining, caused by incorrect handling, transport and/or storage.

The lining herein proposed is an alternative to conventional PTFE (polytetrafluorethylene) lining in sealing profiles for hydraulic flood gates.

The Lining, object of the present improvement, can be applied in all flood gate sealing profiles where it is already used the traditional PTFE (polytetrafluorethylene) lining.

### BACKGROUND OF THE INVENTION

### Concept

Rubber sealings are flexible, adjust to mounting structure irregularities and are easy to handle. However, the friction coefficients, both static and dynamic, in addition to be very close, increase as decreases the sealing hardness.

In the table below, we can view static and dynamic friction coefficient values for flood gate profiles.

| Hardness (Shore A) | Dynamic Coef. | Static Coef. |
|---|---|---|
| 50 | 1.035 | 1.015 |
| 60 | 0.968 | 0.825 |
| 70 | 0.653 | 0.620 |
| 80 | 0.543 | 0.515 |

Note: Values above were determined through laboratory essays, on a dry reference stainless steel surface.

Rubber sealing friction against the structure during motion generates heat and the friction can even lead to flood gate seizure.

So, it is used the PTFE (polytetrafluorethylene) lining to reduce the friction and thus to keep away the possibility of flood gate seizure, allowing to use hydraulic servo-motors less powerful.

In the table below, are indicated static and dynamic (dry) friction coefficient values for flood gate sealing profiles with conventional PTFE (polytetrafluorethylene) lining.

Conventional PTFE Film

Static friction coefficient (CONVENTIONAL PTFE FILM): 0.105

Dynamic friction coefficient (CONVENTIONAL PTFE FILM): 0.088

However, conventional lining application compromises the handling of flood gate sealing profiles.

Incorrect handling and/or transport of flood gate sealing profiles may cause PTFE (polytetrafluorethylene) film wrinkling and ungluing. This is due to the fact of PTFE (polytetrafluorethylene) film to present a plastic flow limit much lower than rubber. So, in accentuated flexions or stretchings, PTFE deforms plastically (and irreversibly), not accompanying rubber elastic recovery, which causes the ‘wrinkling’.

### SUMMARY OF THE INVENTION

Main function of the lining herein proposed is to increase safety during handling, transport and/or installation of flood gate sealing profiles, without significantly compromising the lining friction coefficient.

In the table below are indicated the static and dynamic friction values for flood gate sealing profiles with the lining now proposed in this improvement.

With Improved Lining:

Static friction coefficient: 0.160

Dynamic friction coefficient: 0.156

Friction coefficients are slightly greater than conventional film, but much lesser than sealing without lining.

### BRIEF DESCRIPTION OF THE DRAWINGS

The annexed figures allow for understanding the present proposal before the state-of-the-technique, where:

FIG. 1 shows, along with the enhanced detail, what occurs with the rubber surface when transported.

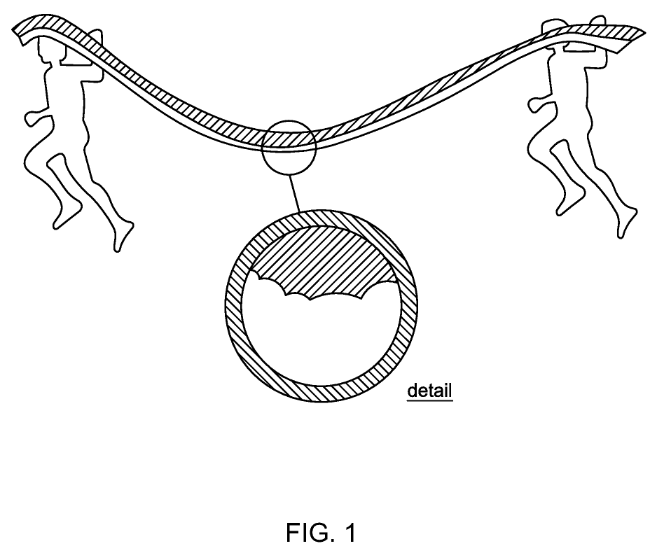

FIG. 2 shows sections of the profile currently employed.

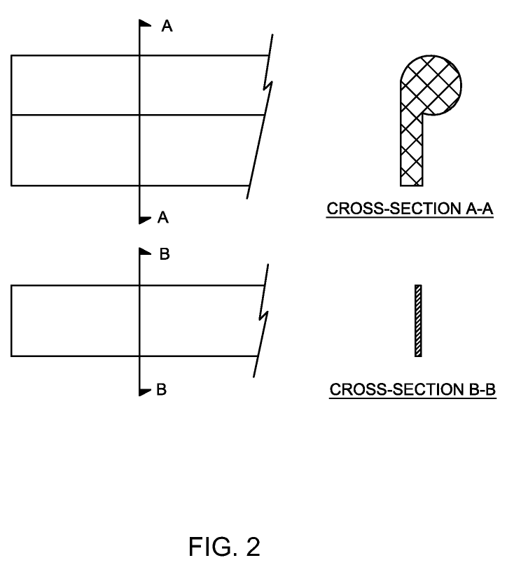

FIG. 3 shows sections of the profile object of the present proposal.

FIG. 4 shows the composition in layers of the present profile.

### DETAILED DESCRIPTION OF A PREFERRED EMBODIMENT

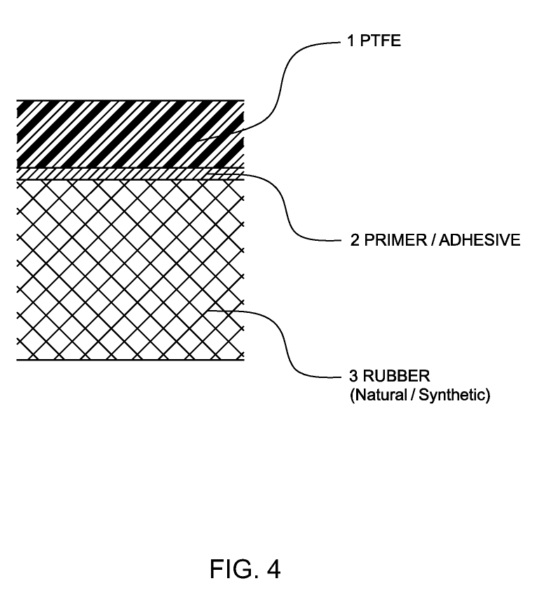

“IMPROVEMENT IN A RUBBER PROFILE FOR FLOOD GATE SEALING, MANUFACTURING SYSTEM AND PRODUCT THEREOF OBTAINED”, of which manufacturing process consists in joining the components described below, as shown in FIG. 4:

[1] PTFE (polytetrafluorethylene) film: sinterized and laminated 0.8 or 1.6 mm thick, chemically treated in one of the faces in order to allow for the adhesion to rubber.

[2] Primer/adhesive: system of organic polymers dissolved in solvent, which promote adhesion of several substrates to the elastomers.

[3] Rubber: synthetic or natural elastomer compound.

Manufacturing steps are thus defined:

1—Film Preparation:

Stamping of the Film of this lining now proposed, with a cutting knife, for opening the relief channels of the PTFE (polytetrafluorethylene) film.

Clean the treated face of this lining now proposed for adherence, using alcohol and a cotton flannel.

Apply the primer on the treated face of this lining now proposed for adherence, covering the entire surface by using a brush.

Wait for drying for nearly 30 minutes.

Apply the adhesive over the primer of this lining now proposed, covering the entire surface by using a brush.

Wait for drying for nearly 30 minutes.

2—Molding:

Pre-mold the Film of this lining now proposed in the mold pre-heated at 160° C., in a C-type press for vulcanization.

Place extruded rubber preformed, non-vulcanized in the mold cavity over this lining now proposed.

Close the mold and apply molding pressure suitable to the profile type.

Wait for the vulcanization time suitable to the profile type.

Relief pressure and open the mold.

Repeat previous steps for the next profile segments.

3—Finish:

Eliminate the excess of Film debris of this lining now proposed, with a manual gritstone or sandpaper.

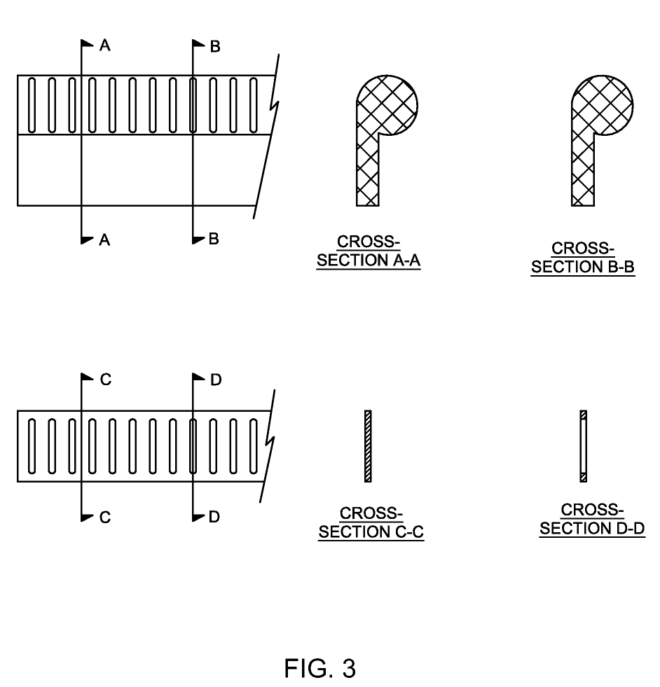

Observe that, according to the views of FIG. 3, the film [1] is transversally grooved [4], these grooves giving dimensional stability to the profile as it is handled.

What is claimed is:

1. A laminate comprising
a first layer of an elastomer, and
a second layer of a polyfluorocarbon,
wherein said second layer further comprises at least one relief channel.

2. The laminate of claim 1, in which the polyfluorocarbon is polytetrafluoroethylene.

3. The laminate of claim 1, in which the second layer contains a plurality of relief channels.

4. The laminate of claim 3, in which the relief channels are parallel.

5. A method for increasing wrinkle resistance in a laminate comprised of an elastomer layer and a polyfluorocarbon layer, comprising the step of creating at least one relief channel in said polyfluorocarbon layer.

6. The method of claim 5, in which the at least one relief channel is created by cutting the polyfluorocarbon layer with a knife.

7. A flood gate sealant comprising a first layer of rubber, a second layer of a polyfluorocarbon, and at least one relief channel cut into the polyfluorocarbon layer to increase the wrinkle resistance of the flood gate sealant.

8. The flood gate sealant of claim 7, in which the polyfluorocarbon layer contains a plurality of relief channels.

9. The flood gate sealant of claim 7, in which the polyfluorocarbon is polytetrafluoroethylene.

10. The flood gate sealant of claim 7 further comprising: [1] PTFE (polytetrafluorethylene) film: sinterized and laminated 0.8 or 1.6 mm thick, chemically treated in one face to allow its adhesion to the rubber; [2] Primer/adhesive: a system of organic polymers dissolved in a solvent, which promote the adhesion of several substrates to elastomers; [3] Rubber: a compound of synthetic or natural elastomer; being the film [1] transversely [4] grooved; being the manufacturing steps defined by:
1—Film Preparation:
Stamping of this lining now proposed, with a cutting knife, for opening the relief channels of the PTFE (polytetrafluorethylene) film;
Cleaning of the treated face of this lining now proposed for adherence, using alcohol and a cotton flannel;
Primer application on the treated face of this lining now proposed for adherence, covering the entire surface by using a brush;
Drying for nearly 30 minutes;
Adhesive application over the primer of this lining now proposed, covering the entire surface by using a brush;
Drying for nearly 30 minutes;
2—Molding:
Pre-molding of the Film of this lining now proposed in the mold pre-heated at 160° C., in a C-type press for vulcanization;
Placement of extruded rubber preformed, non-vulcanized in the mold cavity over this lining now proposed;
Mold closure and application of molding pressure suitable to the profile type;
Waiting for the vulcanization time suitable to the profile type;
Pressure relief to open the mold;
Repeat of previous steps for the next profile segments;
3—Finish:
Elimination of the excess of Film debris of this lining now proposed, with a manual gritstone or sandpaper.
